(19) United States
(12) Patent Application Publication
(10) Pub. No.: US 2005/0222961 A1
(43) Pub. Date: Oct. 6, 2005

(54) System and method of facilitating contactless payment transactions across different payment systems using a common mobile device acting as a stored value device

(76) Inventors: Philippe Staib, Bangkok (TH); James Helm, Bangkok (TH); Thierry Renard, Bangkok (TH)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/940,939

(22) Filed: Sep. 14, 2004

Related U.S. Application Data
(60) Provisional application No. 60/559,818, filed on Apr. 5, 2004.

(51) Int. Cl. H04L 9/00

(52) U.S. Cl. 705/64

(57) ABSTRACT

A system for facilitating contactless payment transactions across different contactless payment systems using a common mobile device that acts as a stored value device is provided. A combination of a mobile application and a communication module allows the mobile device, which is associated with one payment system, to emulate various transmission standards and data exchange formats that are used in different payment systems in order to perform contactless payment transactions with merchants that are associated with different contactless payment systems. A service application running in a service operator computer communicates with the various contactless payment systems to facilitate the settlement of the amount owed to various payment systems by the one payment system associated with the mobile device.

### CROSS REFERENCE TO RELATED APPLICATIONS

This application claims priority to U.S. provisional patent application No. 60/559,818, filed Apr. 5, 2004, which is incorporated herein by reference.

### FIELD OF THE INVENTION

This invention relates to mobile commerce, and more particularly electronic payment systems for portable devices that act as smart cards.

### BACKGROUND OF THE INVENTION

Millions of consumers across the world are already paying for purchases of goods and services using contactless payment, with millions more expected in the years to come as new contactless payment initiatives are launched in many different countries.

Consumers love the convenience and speed of paying with a contactless card or other contactless device with no more fumbling for cash, counting change, or worry about whether they have enough cash for a purchase. In many cases, consumers don't even need to sign a payment card receipt or enter a personal identification number (PIN).

Contactless payment is particularly attractive in merchant segments where speed and convenience of payment are essential, for example, quick service restaurants, gas stations, convenience stores, parking facilities, transit services, entertainment venues, and unstaffed vending locations.

Contactless payment can include account-based payment, traditional credit or debit card payment, and stored value payment. Transaction processors (card operators) such as American Express, JCB, MasterCard, and Visa have all conducted pilot programs for contactless payment. Major cities around the world already use contactless cards for transit payment, with major cities in the United States also implementing or planning to implement contactless card-based automatic fare collection (AFC) systems.

Consumers are already using a number of contactless payment options in a variety of situations. Consumers purchase gasoline, fast food, and groceries. They pay millions of dollars in tolls and fares using a contactless tag device. One contactless payment system in Hong Kong, for example, processes 7.5 million transactions per day for 160 different merchants.

Contactless payment requires a wireless information exchange between a consumer's payment token and a payment terminal or infrastructure device. Contactless payment can be enabled using a variety of technologies and tokens. Radio frequency (RF) technology has been used for most of the contactless payment initiatives. These systems use high-frequency solutions, low-frequency proprietary RF solutions, and ultra-high-frequency RF solutions.

ISO/IEC 14443 is a contactless smart card technology standard operating at a high frequency of 13.56 MHz. This standard was initiated in 1994 to standardize contactless payment cards and finalized in 2001. To date, approximately 250 to 300 million contactless cards that are based on the ISO/IEC 14443 standard have been shipped. The majority of these cards are used in transportation applications for automatic fare collection, with the largest installations in Asia. ISO/IEC 14443 cards are supplied by the largest base of semiconductor suppliers and card manufacturers.

Some payment systems use a proprietary high-frequency 13.56 MHz contactless technology and are used extensively for transit applications in Asia Pacific markets such as Hong Kong and Japan and, to a more limited extent, in the United States. Examples of such technology include the FeliCa™ card used by Hong Kong transit system and the Go Card™ used by a number of large transit operators. The FeliCa card uses the same frequency and form factor as ISO/IEC 14443-compliant cards but differs in some technical specifications. The Go Card™ technology uses the same frequency, modulation schemes, bit coding, and form factor as ISO/IEC 14443 Type B-compliant cards but differs in other technical specifications.

Another technology in use is a proprietary low-frequency 125 to 134 KHz RF technology. The low-frequency RF technologies operate at less than 300 KHz. These technologies typically use a unique ID within an application and therefore are most often referred to as RFID technology. Such technologies have been used extensively for security applications such as automobile immobilizers and for access control. The Speedpass™ system is an example of the low-frequency RFID technology for payment in North America. The Speedpass™ technology operates at 134 KHz and can achieve ranges up to 10 centimeters but has a relatively low data-transfer rate. Low-frequency RFID technologies have no established communications standards at present and the RF tag has very limited processing power.

The most predominant form factor used for low-frequency RFID payment is the key fob or key chain device, but both automobile-mounted tags and tags embedded in watches are also commercially available. The auto tags are active tags, requiring a battery that must be replaced every 3 to 4 years.

Another contactless technology is a proprietary ultra-high-frequency RF technology which typically operate in the ISM band (902 to 928 MHz in the United States) and has an operational range of anywhere from 3 meters to more than 10 meters. These technologies generally use a unique ID within the application, so they are also referred to as RFID technology. The best example of the use of the ultra-high-frequency RF technology that is applicable to payment applications is the use of RF transponders to pay highway tolls, such as the E-ZPass™ system (used in the northeastern United States), TollTag™ (used in the Dallas metropolitan area), and FasTrack™ (used in California).

However, a major limitation with the existing prior art for contactless payment is related to the ability of a consumer equipped with a contactless payment device to use the same device on different contactless payment systems. This limitation originates from the following factors among others: different RF technologies, different payment applications, and different settlement systems.

As discussed above, there are four main RF technologies that are used for contactless payment applications today. A contactless payment device for use with one RF contactless payment technology cannot be used with a different RF contactless payment technology.

Even if the RF technology is the same, the contactless payment systems in commercial operation and in development today use different software applications and settlement systems. For instance, the contactless payment systems deployed by the payment card (credit and debit card) companies use the existing settlement system and infrastructure already in place for payments with the standard card products, with applications developed for use with this existing infrastructure and settlement system. However, other contactless payment systems use different applications and settlement systems. For instance, the Octopus card in Hong Kong is based on a rechargeable stored-value account in the card, with the operator of the Octopus card settling directly with the merchants accepting the Octopus card for payment. Contactless payment systems use different underlying funding process for the transactions by the consumers on these systems, such as account-based payment, traditional credit or debit card payment, and stored value payment.

Accordingly, a user equipped with a contactless payment device that has been enabled for a specific contactless payment system cannot use the same device on other contactless payment systems, even if the contactless RF payment technology is the same. This is because the applications in the contactless payment device are designed based on the specific requirements, such as data exchange, security, and settlement, of that specific contactless payment system, which are different for each contactless payment processing system.

Another limitation of the prior art systems is that the stored value account can only be recharged using dedicated hardware such as dedicated recharge terminals, recharge points, or specific ATM type terminals with recharge capability.

Therefore, it is desirable to provide a contactless payment system that links multiple payment systems to allow a user with a single mobile contactless device to pay for good and services that are provided across different contactless payment systems.

It is also desirable to provide a contactless payment system that allows the user to recharge the stored value in the mobile contactless device anywhere without requiring the user to be near a dedicated hardware terminal.

### SUMMARY OF THE DISCLOSURE

According to the principles of the present invention, a system for facilitating contactless payment transactions across a plurality of different contactless payment systems using a common mobile device that acts as a stored value device is provided.

A mobile application running in the mobile device is associated with one contactless payment system. While the mobile device is not associated with other contactless payment systems, it can nevertheless perform contactless payment transactions with merchants that are associated with those other payment systems by emulating the transmission standards and data exchange formats used by those payment systems.

Once the transactions take place, a service application running in a service operator's computer communicates with the various contactless payment systems to settle the amounts owed to other contactless payment systems by the one contactless payment system that is associated with the mobile device.

The combination of the mobile application and the service application provide a complete solution to allow a common mobile device to pay for goods and services through merchants that are associated with different payment systems as well as subsequent settlement of payments among the different payment systems.

### BRIEF DESCRIPTION OF THE DRAWINGS

FIG. 1 is a functional block diagram of a payment processing system according to the present invention.

FIG. 2 is a block diagram of a smart mobile device containing a processor chip, a stored value and a contactless communicator according to the present invention.

FIG. 3 illustrates a process flow of a contactless purchase transaction using a smart mobile device associated with a particular payment system according to the present invention.

FIG. 4 illustrates an alternate process flow of a more secure contactless purchase transaction using a smart mobile device and a subsequent settlement of payment according to an alternative embodiment of the present invention.

FIG. 5 illustrates a flow of an encrypted payment token to ensure payment and reduce payment disputes according to the present invention.

FIG. 6 illustrates an overall diagram and process flow of an inter-operable payment and settlement system according to the present invention in which a user belonging to one contactless payment system purchases an item in a different contactless payment system using the same mobile device.

FIG. 7 is an exemplary process flow of the payment and settlement system of FIG. 6 where a user residing in Hong Kong travels to Thailand and purchases an item in Thailand.

FIG. 8 illustrates a process flow of a remote charge and recharge of stored value in the smart mobile device according to the present invention.

FIG. 9 illustrates an alternative process flow of a remote charge and recharge of stored value in the smart mobile device according to the present invention.

### DETAILED DESCRIPTION OF THE INVENTION

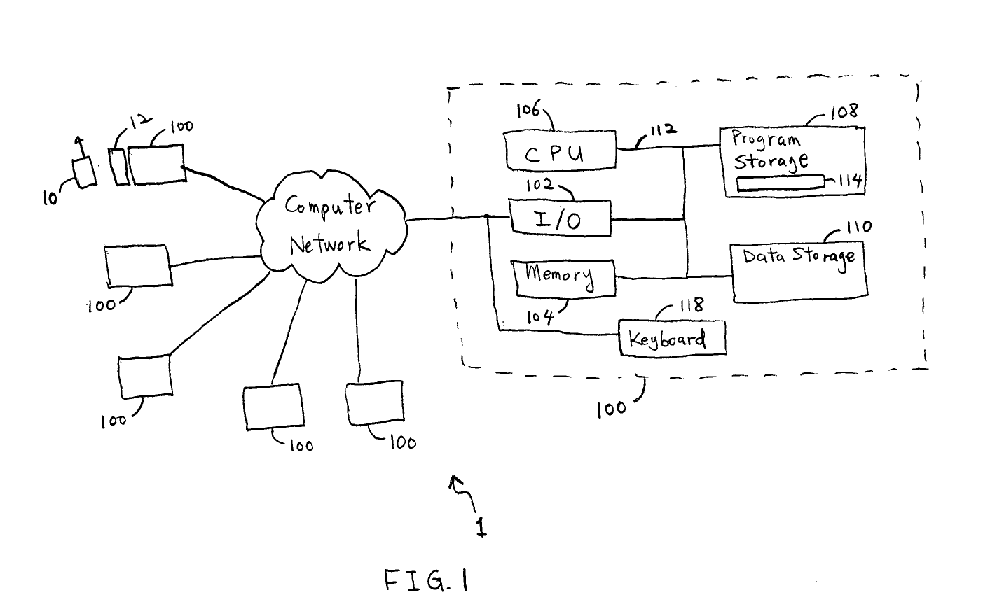

Referring now to FIG. 1, a payment processing system 1 of the present invention comprises a plurality of computers 100 that are connected to each other through a computer network such as the Internet. The computers 100 of the system 1 cooperate with each other to provide comprehensive processing and settlement of purchase transactions that are made by the same mobile device across different payment systems regardless of the difference in transmission technology, processing applications or settlement applications.

As illustrated in FIG. 1, each computer 100 is connected to a computer network such as the Internet through, for example, an I/O interface 102, such as for a LAN, WAN, or fiber optic, RF or cable link, which receives information from and sends information to other computers 100 and smart mobile devices 10. Each computer 100 is also connected to a keyboard 118 for controlling the computer.

Each computer 100 includes a memory 104, processor (CPU) 106, program storage 108, and data storage 110, all commonly connected to each other through a bus 112. The program storage 108 stores, among others, payment processing and settlement software programs or modules 114. Any of the software program modules in the program storage 108 and data from the data storage 110 are transferred to the memory 104 as needed and is executed by the processor 106.

Computers 100 at merchant locations 22 are connected to contactless reader (contactless communicator) 12 at the point of sale which are adapted to communicate with smart mobile devices 10 for facilitating purchase transactions. The system 100 can be any computer such as a WINDOWS-based or UNIX-based personal computer, server, workstation or a mainframe, or a combination thereof. While the system 100 is illustrated as a single computer unit for purposes of clarity, persons of ordinary skill in the art will appreciate that the system may comprise a group of computers which can be scaled depending on the processing load and database size.

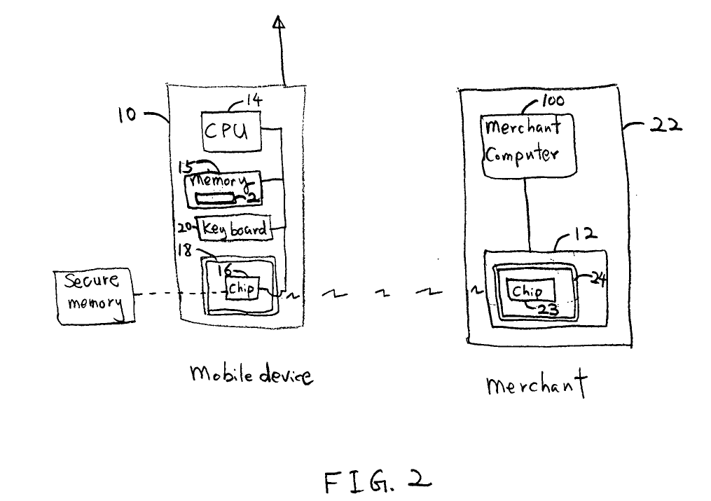

Referring to FIG. 2, the smart mobile device 10 in this embodiment is a mobile telephone containing a CPU 14, an input device 20 such as a keypad connected to the CPU and a memory 15 storing a mobile application 2 and the stored value (digital cash) which is stored in a secured area of the memory 15. The keypad 20 controls the mobile device 10. A communication module (NFC) 16 connected to the CPU 14 includes a communication chip and may also contain its own processor for handling data encryption and the like and secure memory area for storing the stored value. In an alternative embodiment, an external module may be connected to the NFC chip 16 which would comprise a secure storage area which in turn would contain its own processor and operating system. This external module can be used to store the stored value in its secure memory area. Still in another alternative embodiment, the stored value can be stored in a separate hardware such as in a USIM (Universal Subscriber Identity Module) (not shown) which is in communication with the NFC module 16.

The NFC module 16 is connected to its own antenna 18 and the CPU 14 of the smart mobile device 10. Although FIG. 2 shows a mobile telephone that acts as a smart card, the contactless device (comprised of the chip 16 and antenna 18) that can communicate with the contactless communicator/reader 12 can be incorporated into a variety of portable devices such as a PDA, notebook computer, key chain, traditional plastic card, pager devices, watch or the like.

At a merchant 22 where goods and services are rendered, the contactless communicator 12 is the RF reader device that communicates with the mobile device 10 to facilitate the purchase and payment. Similar to the mobile device 10, the contactless communicator 12 contains a chip (NFC module) 23 and an antenna 24. A merchant computer 100 running a merchant application software 39 at the retail location 22 is connected to the NFC module 23 for processing the purchase transaction.

In one embodiment, the NFC module 16 and the antenna 18 are based on RFID technology called NFC (“Near Field Communication”) which enables wireless interface between two devices. NFC is a short range technology that supports communication at distances measured in centimeters. The devices have to be literally almost touched to establish a communication link between them. This has two important advantages. One, the devices are inherently secure since they need to be placed very close to the communicator 12. Two, NFC technology supports passive mode of communication. This is very important for the battery-powered devices since conservation of energy is a high priority. The NFC protocol allows such devices as a mobile phone to operate in a power-saving mode—the passive mode of NFC communication. This mode does not require both devices to generate the RF field and allows the complete communication to be powered from one side only. Of course, the device itself will still need to be powered internally but it does not have to waste the battery on powering the RF communication interface.

The NFC protocol is also compatible with a wide variety of contactless smart card protocols.

In the embodiment shown, software applications that can be downloaded to and executed by the processor 14 of the smart mobile device 10 for communication with and control of the NFC module 16 is done using J2ME MIDP (Mobile Information Device Profile), Version 1.0 and 2.0. The MIDP 1.0 provides core application functionality required by mobile applications, including basic user interface and network security. The MIDP 2.0 further provides new features such as an enhanced user interface, multimedia and game functionality, greater connectivity, over-the-air (OTA) provisioning, and end-to-end security. In various implementations, there may be an external security module and storage area attached to the NFC interface. This secure module may have the ability to utilize the operating system of the mobile phone 10 to create secure internet connections for the purposes of transferring data directly from the secure storage to the service operator 48.

MIDP 2.0 adds a robust end-to-end security model, built on open standards, that protects the network, applications and mobile information devices. MIDP 2.0 further supports HTTPS and leverages existing standards such as SSL and WTLS to enable the transmission of encrypted data. In MIDP 2.0, security domains protect against unauthorized access of data, applications and other network and device resources by MIDlet suites on the device, which are small application programs similar to Java applets. By default MIDlet suites are not trusted, and are assigned to untrusted domains that prevent access to any privileged functionality. To gain privileged access, a MIDlet suite should be assigned to specific domains that are defined on the smart mobile device 10, and should be properly signed using the X.509 PKI security standard. In order for a signed MIDlet suite to be downloaded, installed and granted associated permissions, it should be successfully authenticated.

Instead of MIDP, other standards such as the BREW™ specification developed by Qualcomm Inc. of San Diego, Calif. and Windows Mobile™ operating system developed by Microsoft Corporation of Redmond, Wash. may be used.

A contactless payment transaction involves the following players: service operator 48, wallet operator 50, users who subscribe to the payment services of the service operator, financial institutions 49 holding deposit accounts of the users, and merchants 22 who provide goods or services.

The service operator 48 provides the software and information technology requirements of the payment clearing service of all purchase transactions. The wallet operator 50: 1) receives customer's money on its bank account from the customer's bank during the initial load and top up of the stored value; 2) pays the merchants 22 or the contactless payment networks with roaming agreements for customer's transactions; 3) converts stored value into foreign currency when the customer goes abroad and coverts it back into home currency when the customer returns; 4) pays wallet operators of different contactless payment systems whether they are located in other areas or the same areas. The functions provided by the service operator 48 and wallet operator will be explained in detail later herein.

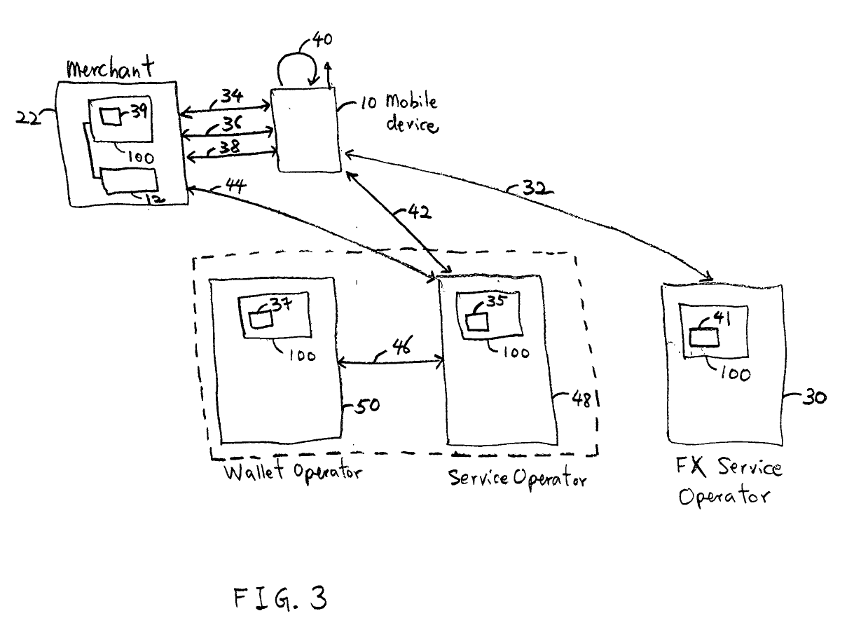

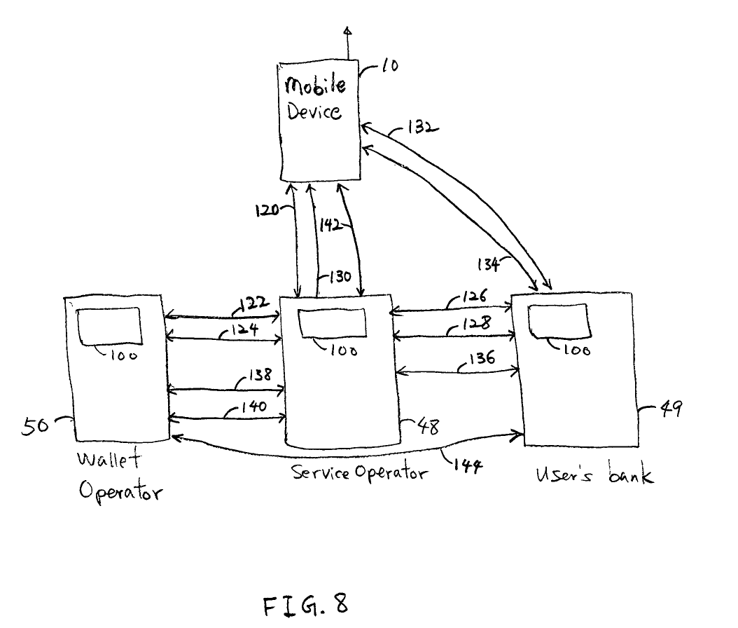

Initially, a user signs up for a contactless payment service with the service operator 48. The wallet operator 50 has an existing arrangement with the bank 49 holding the user's deposit or credit card account (see FIG. 8). During sign-up, a predetermined amount of money is transferred into a bank account of the wallet operator 50 and is written into the secured area of the memory 15 of the smart mobile device 10 as a stored value. The mobile device 10 is now associated with a particular payment system or network such as shown in FIG. 3 which shows the merchant 22, mobile device 10, service operator 48 and wallet operator 50 all associated with a single payment system or network. The merchants 22 have an existing arrangement with the service operator 48. Once goods or services have been rendered, the merchant 22 presents a payment request to the wallet operator 50.

The wallet operator 50, which essentially acts as a bank, may be a part of the service operator 48 or a separate entity that has an existing agreement to handle all financial aspects of the contactless payment transactions for the service operator 48.

A more detailed explanation is made below with reference to FIG. 3, which illustrates a process flow of a purchase transaction of a smart mobile device associated with a particular payment system and subsequent settlement of payment.

Step 32 is an optional step that is executed only when the user is traveling to a foreign country and needs to convert the currency of the stored value into the respective foreign currency. In this step, using the mobile device 10, the user executes a mobile application program 2 stored in the memory 15 which was developed using MIDP 2.0. When a “roaming” option and a particular foreign country is selected, the mobile application program 2 determines whether a cross border application 41 is loaded into the memory 15. If not, the mobile program downloads the cross border application 41 (plug-in module) stored in the computer 100 of a foreign exchange service operator 30. The cross border application 41 can be downloaded through OTA (Over The Air) download through a mobile telephone operator network over SSL GPRS connection or by a distributor installed via NFC. In a deployment where an external security module is used, the mobile phone 10 may be used to create a secure Internet connection to the service operator 48 and that the data and/or application are transferred directly from the secure storage area to the service operator or vice versa as required. In one embodiment, the service operator 48 also serves as the foreign exchange service operator 30 and the wallet operator 50 as a single entity. The cross border application 41 is executed by the processor 14 and is capable of reading the currency stored in the mobile device 22, converting it into the appropriate foreign currency and writing the new converted value into the mobile device. The cross border application 41 is also capable of emulating the RF standard and data exchange standards of the payment system in use in that foreign country.

In step 34, the user is ready to purchase an item. The user places the mobile device 10 near the contactless communicator 12 to initiate a payment for the purchase of the item. At the merchant location 22, a merchant application 39 is stored in the memory of a merchant computer 100. In step 36, the contactless communicator 12 queries the mobile NFC device 10 for the stored value stored in the mobile device. At that point, the mobile device 10 together with the mobile application 2 determines the payment system in use by the merchant and places the mobile device in an emulation mode to emulate the transmission standard and data exchange format used by the merchant 22.

The determination of which particular payment system is in use can be done automatically by the mobile application 2 and the merchant application 39. Specifically, the merchant application 39 transmits an ‘application id’ to the mobile device 10 through the merchant communicator 12, which is received by the NFC module 16. The mobile application 2 (global application which is a part of the mobile application) looks up the ‘application id’ within a list of the applications stored within the mobile device 10. The application id is stored the mobile device when the mobile application 2 is installed. Each ‘application id’ is unique and registered in the global application portion of the mobile application 2. When a match is found, the mobile application sets the mobile device in an emulation mode to emulate the transmission standard and data exchange format required by the payment system in use.

Alternatively, the mobile application 2 can manually determine the payment system in use by receiving from the user a selection of the payment system/network among many payment systems in a menu displayed by the mobile application.

The merchant's communicator 12 then authenticates itself with the mobile device 10 so that the mobile device recognizes the merchant as a legitimate merchant. Once authenticated, the communicator 12 sends a “read command” for the stored value.

In step 38, in response to the query, the NFC module 16 on the mobile device 10 passes data back to the merchant computer 100 in an encrypted form. The data includes the stored value, customer ID, transaction ID, time stamp and the like. After decrypting the data, the merchant application 39 determines whether the stored value is sufficient to pay for the item being purchased. If yes, then the merchant application 39 calculates the balance and passes the balance data to the mobile device 10 in an encrypted form to be stored in the mobile device 10. Then, the merchant application 39 stores the transaction details in its database.

In step 40, the user deactivates or closes the cross border application 41. This step is the reverse of step 32 to change the stored value currency back to the user's local currency. The stored value data is converted back to the default application data format and the mobile application 2 updates the new wallet balance. The mobile application 2 then deactivates the cross border plug-in module 41.

Steps 42 to 46 generally occur at a later time and are not required for the payment transaction to be completed from the user's perspective.

As with the merchant 22, the service operator 48 and the wallet operator 50 each have a computer 100 that stores a service application 35 and wallet application 37 in the memory 104, respectively, to settle the payment from users to merchants.

In step 42, at a later point in time, the mobile application 2 in the mobile device 10 connects to the computer of the service operator 48 and transmits all of the transactions that were made from the previous update. The transaction history stored in the service operator 48 computer 100 for that user is then updated by the service application 35. Typically, the transaction history is transmitted through the Internet via SSL over GPRS. In step 44, the merchant application 39 in the computer 100 of the merchant 22 retrieves all of the payment transactions and transmits a settlement request containing all of the payment transactions to the computer 100 of the service operator 48. The service application 35 compares the received payment transactions with its database of transaction history for various users for reconciliation. When the payment transactions are reconciled and verified, the service application 35 in the service operator computer 100 instructs the wallet application 37 running in the wallet operator 50 to pay the merchant 22 in step 46.

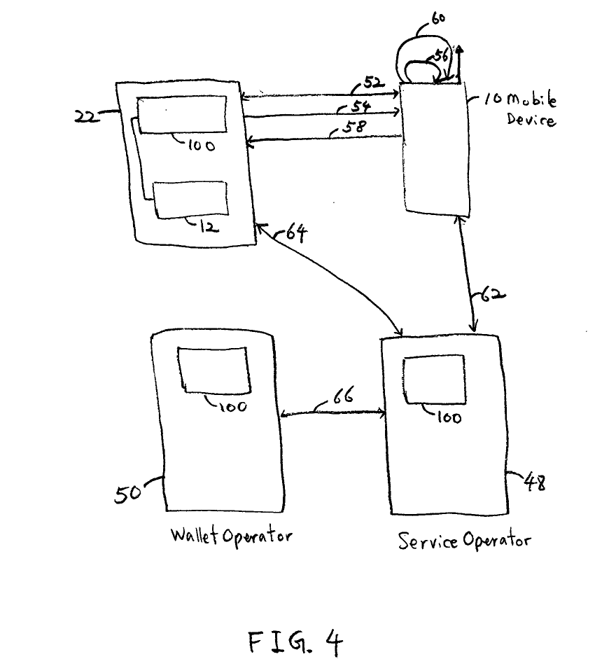

FIG. 4 is an alternate process flow of a more secure purchase transaction of a smart mobile device and subsequent settlement of payment.

In step 52, the user activates the mobile application 2 stored in the memory 15 of the mobile device 10. The user then places the mobile device 10 near the merchant contactless communicator 12 to initiate payment. Alternatively, the mobile application 2 is automatically activated when the mobile device 10 is placed near the merchant contactless communicator 12. In step 54, the merchant application 39 recognizes the presence of the mobile device 10 and transmits a merchant identification/password. Specifically, the merchant application transmits a write command through the contactless communicator antenna 24 with data consisting of a merchant ID, followed by an encrypted string containing merchant ID, transaction ID, merchant's user name and password issued by the wallet operator 50, transaction amount, date and time, product description, and the like.

In step 56, the NFC/MIDP 2.0 application interface running in the mobile device 10 reads the transmitted data and authenticates the merchant. In one embodiment, the merchant authentication is done in two steps. In the first step, the received merchant ID is used to generate a dynamic key based on merchant's ID and date stamp. The dynamic key is then used to decrypt the encrypted data string. In the second step, an internally stored algorithm known only to the mobile application 2 is used to verify the decrypted merchant's user name and password.

The mobile application 2 in the mobile device 10 validates the stored value amount from the stored value and the received transaction amount. If the stored value is greater than or equal to the received transaction amount and the merchant is authenticated, the mobile application 2 approves the transaction and creates a payment token, which will be discussed in detail later herein. The mobile device 10 stores the details of the transaction in a transaction log. The remaining stored value is then written to the secured memory of the mobile device 10. Then, the mobile application 2 transmits the payment token to the merchant 22 contactless communicator 12, which is used by the merchant as proof of payment by the user.

The payment token feature is a way of enhancing security for all participants of a contactless smart card transaction. In a conventional contactless smart cart transaction, a contactless communicator 12 at the merchant 22 receives from a user's contactless smart card chip in encrypted digital form the contactless smart card number and the value equivalent to the amount of the transaction. The value stored on the contactless smart card chip 16 is updated with the new balance available. However, the contactless smart card is not updated with the details of the transaction (such as merchant ID, transaction amount and contactless terminal ID). Accordingly, there is the possibility that the user of the contactless smart card may dispute a payment, as there is no proof in the contactless smart card of such payment. There is also the possibility of loss of value from the contactless smart cards, both accidentally or by theft, by way of a contactless communicator being at close proximity to the contactless smart card and automatically triggering a download of value from the contactless smart card. According to the present invention, however, use of the payment token feature prevents such a loss of value by allowing a full trace of such events.

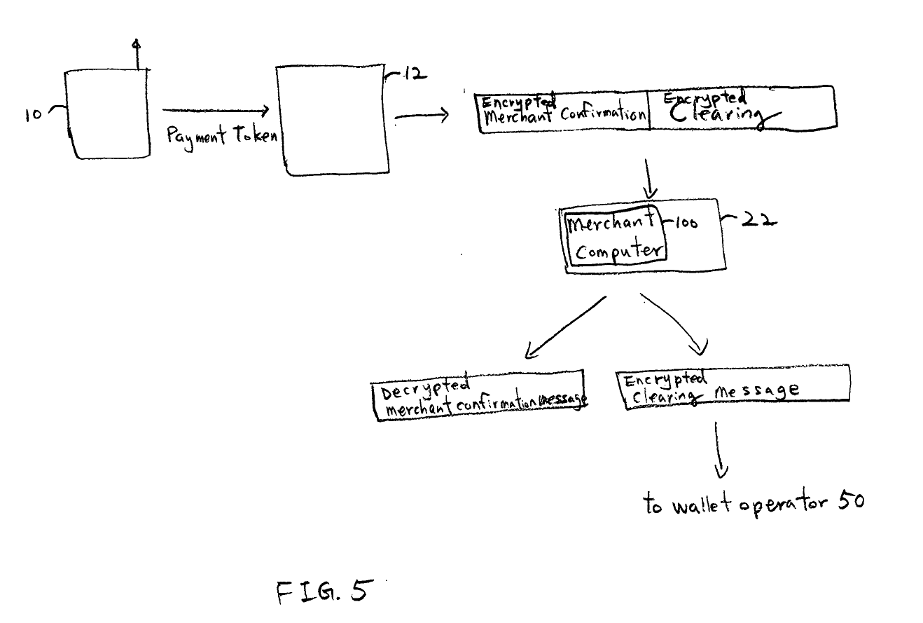

The payment token in step 56 is created by the mobile application 2 when a transaction is approved by the mobile device 10. As illustrated in FIG. 5, the payment token contains two text string messages: 1) a merchant confirmation message; and 2) a clearing message. The merchant confirmation message is an encrypted string using a merchant specific key and the clearing message is an encrypted string using a separate private key. Both keys are stored in a secured memory area of the mobile device 10 and the CPU 14 performs the encryption.

The merchant confirmation message is encrypted using a symmetric security key. The key is stored in the mobile application 2 and in the contactless communicator 12 at the merchant 22. Each merchant has a different key. The merchant 22 can decode or decrypt the merchant confirmation message which contains payment status information such as approval code, user number (e.g., mobile serial number) and the like.

The clearing message contains all the transaction information including merchant ID, transaction ID, customer ID, data and time, transaction amount, transaction description, confirmation code and the like. The clearing message is encrypted with a symmetric key that is only known by the wallet operator and the mobile application (the key being stored in the secure area). By using this approach, the overall flow is not dependent on the security of the merchant POS devices. An example of encryption technology that could be used is 3DES, which is a standard encryption technology for financial institutions. The merchants do not have access to the key.

In step 58, the merchant contactless communicator 12 receives the payment token from the mobile device. The merchant application 39 decrypts the merchant confirmation message to see whether the transaction has been approved by the mobile device 10. The status is displayed at a display of the merchant computer 100. The transaction details are then stored in the merchant computer's database. On the other hand, the clearing message portion cannot be decrypted by the merchant. Accordingly, the payment token including the merchant confirmation message and the clearing message both in their encrypted form is stored in the merchant computer's database for later transmission to the wallet operator. Normally, only the clearing message portion of the payment token is sent to the wallet operator 50 for settlement later.

In step 60, the mobile application 2 updates the remaining stored value stored in the mobile device 10 once it receives confirmation from the merchant 22 computer 100 that the payment token has been received.

Steps 62 to 66 generally occur at a later time, and are not required for the payment transaction to be completed from the user's perspective.

Step 62 is similar to step 42 of FIG. 3. At a later point in time, the mobile application 2 in the mobile device 10 connects to the computer of the service operator 48 and transmits all of the transactions that were made from the previous update. The transaction history stored in the service operator computer 100 for that user is then updated by the service application 35. In step 64, the merchant application 39 in the merchant 22 computer retrieves all of the stored payment tokens and transmits a settlement request containing the retrieved tokens to the service operator 48 computer. The service application 35 decrypts the clearing messages using the symmetric key. The service application 35 then instructs the wallet application 37 running in the wallet operator 50 computer to pay the merchant 22 in step 66.

Alternatively, the service application 35 decrypts the clearing messages using the symmetric key, compares the decrypted payment transactions with its database of transaction history for various users for reconciliation. When the payment transactions are reconciled and verified, the service application 35 instructs the wallet application 37 running in the wallet operator 50 computer to pay the merchant 22 in step 66.

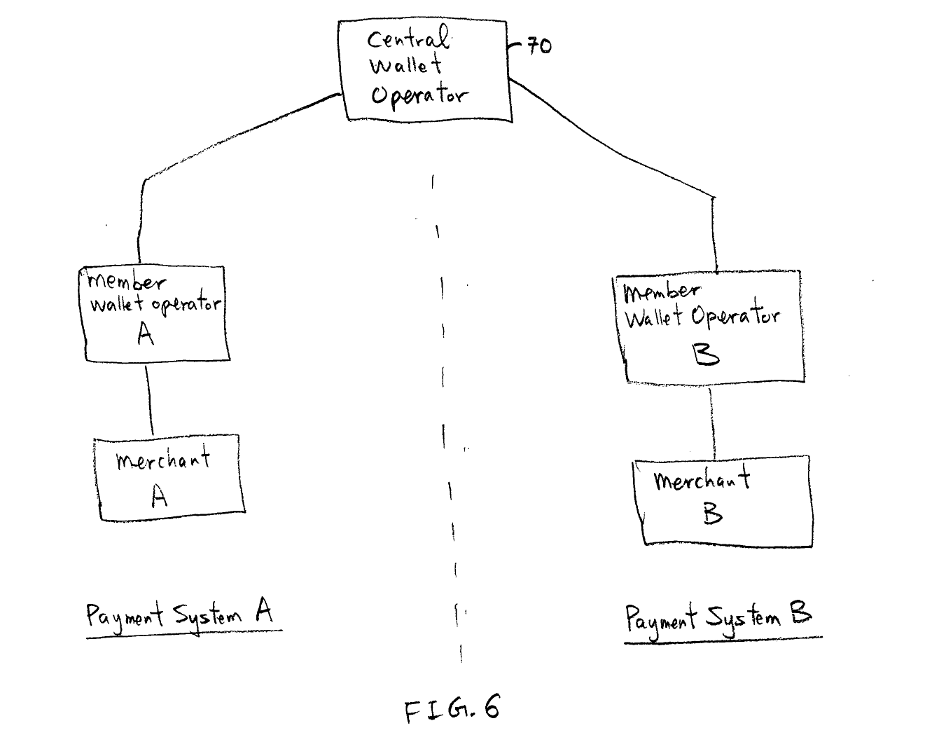

FIG. 6 illustrates an overall diagram and process flow of an inter-operable payment and settlement system according to the present invention in which a user belonging to one contactless payment system purchases an item in a different contact payment system. The different payment systems may be operating in the same area, different areas of a country or in different countries altogether. As an example, the user may belong to a contactless payment system specifically designed for paying transit fares, but would like to use the device to pay for a highway toll which belongs to a different contactless payment system. The transit payment system and the highway toll payment system may be located in the same area, different states or in different countries. The present invention allows the user of one payment system to use other payment systems using a single smart mobile device as will be explained in more detail below.

Assume that “A” and “B” are different countries and wallet operator A operates a contactless payment system in Country A while wallet operator B operates a contactless payment system in Country B. Further assume that the user is a member of wallet operator B, and would like to travel to country B and use his smart mobile device 10 to pay for items. The user has a predetermined amount stored in the secured memory of the smart mobile device 10. Although not illustrated for purposes of clarity, each operator and merchant has its own computer 100 that runs application programs that communicate with each other and with the mobile application 2 so that the user can use the same mobile device 10 to make contactless purchase transactions across multiple payment systems. Also, as discussed previously, a wallet operator is typically the same entity as a service operator.

To use the digital cash represented by the stored value in the chip 16, the user selects Payment system A” displayed among one of many payment system options in the smart mobile device 10. In the event that the mobile application 2 determines that software for performing payment transactions in country A is not present, it will use an Internet connection enabled by the mobile device 10, e.g., GPRS, to download from a remote client server the required software update to the mobile application 2. The payment transaction application for country A can be located in the foreign exchange server 30, wallet operator 50 or the service operator 48.

In the event that the currency to be used for payments on contactless payment system “A” is different from the currency of the user's electronic purse, the user is requested, when selecting contactless payment system “A”, to convert the balance of stored value in the electronic purse into the currency to be used for payments on contactless payment system “A”. The user has the option of converting all of a portion of the stored value. The conversion is done by the mobile device 10 by connecting to the foreign exchange server 30 using an Internet connection enabled with the mobile device (e.g., GPRS) as detailed in step 32 of FIG. 3.

When the user wants to pay for a product with merchant A participating in contactless payment system A, the user brings his mobile device 10, with the mobile application 2 activated, within the required range of the contactless communicator 12 installed at the merchant 22. Similar to steps 34-38 of FIG. 3, the merchant 22 computer decrypts the data when necessary, performs the business logic of the transaction (e.g., checks balance and deducts the amount, or rejects the payment), creates the new balance data to be stored on the NFC module 16 and then sends a write command to store this new data in the NFC module.

According to the invention, the mobile application 2 together with the NFC smart chip 16 can emulate many different RF standards operating at various frequencies and emulate the specific data exchange formats and data structures of the messages between the mobile device 10 and the communicator 12 which are required for a particular payment system. The data exchange between the contactless communicator 16 and the mobile device 10 takes place based on the data exchange requirements of contactless payment system A, with the mobile application 2 in the mobile device formatting the data based on these requirements and communicated to the contactless communicator 16 by way of the NFC module 16 embedded in the mobile device 10, which is activated by the mobile application 2 in the mode required for communication based on the RF technology used by the contactless communicator 12 (e.g., in the proprietary high-frequency 13.56 MHz Octopus system in Hong Kong).

Once the payment transaction is completed and the merchant 22 has received a payment confirmation from the mobile device 10 (for example, in the form of a payment token as discussed above with respect to FIG. 3), merchant A presents a settlement claim to wallet operator A using a merchant application 39 running in the merchant 22 computer and receives money for the purchase transaction based on a settlement process of contactless payment system A. The steps are similar to steps 42-46 of FIG. 3 or steps 62-66 of FIG. 4.

Wallet operator A then presents a settlement claim to the central wallet operator 70 through the wallet application 37 running in the wallet operator A's computer. Wallet operator A can be paid in several different ways. If one embodiment, the central wallet operator acts as simply a central clearing agent netting out what wallet operator B owes to wallet operator A, and send an instruction through a computer link to wallet operator B's computer to pay the net amount owed to wallet operator B. In another embodiment, the central wallet operator pay the net amount to wallet operator A and sends a payment request for the same amount to the wallet application 37 running in the wallet operator B's computer.

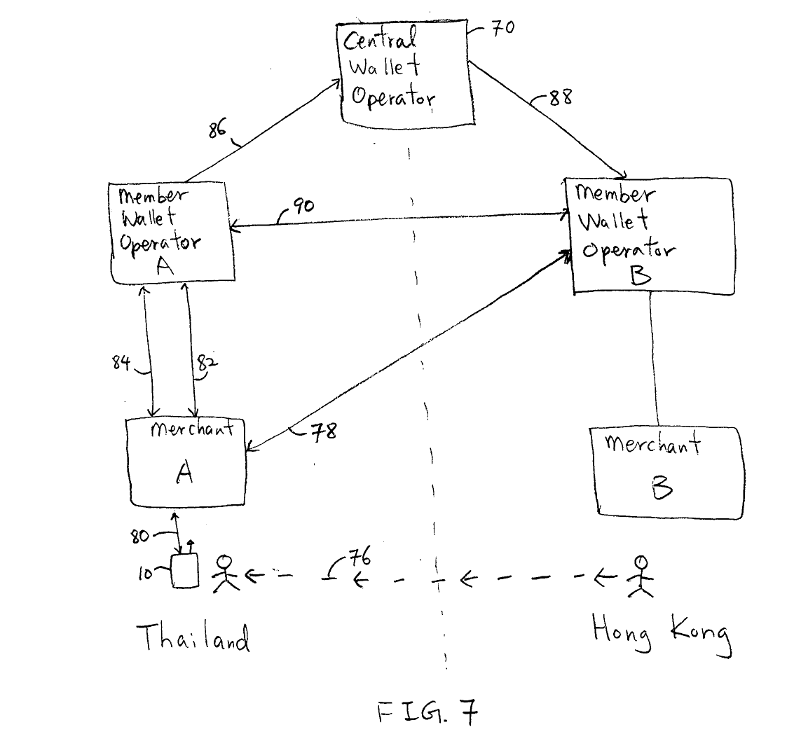

FIG. 7 is an exemplary process flow of the payment and settlement system of FIG. 6 where a user residing in Hong Kong travels to Thailand and purchases an item in Thailand.

In step 76, a user who is a Hong Kong businessman travels to Thailand with a smart mobile device 10 associated with wallet operator B operating the Octopus Card in Hong Kong. The user wants to use the Bangkok Subway Contactless Payment System which is operated by wallet operator A. On the smart mobile device 10, the user selects “Bangkok Subway Contactless Payment System” appearing on the menu. In step 78, the cross border application 41, downloaded from wallet operator B, running in the mobile device 10 requests the user to convert the 400 HGK$ value of his electronic purse into 1,980 Thai Baht based on an exchange rate of 1 HGK$=5 THB minus exchange commission of 1% charged by wallet operator A.

In step 80, the user makes a payment for THB 1,000 on Bangkok Subway Contactless Payment System (merchant) using the mobile device 10. In step 82, based on a set of pre-arranged rules, Bangkok Subway Contactless Payment System presents a settlement claim to wallet operator A in Thailand for THB 1,000 minus agreed fee (in this case 0.5%, i.e., 995 THB). In step 84, wallet operator A in Thailand instructs a transfer of 995 THB from its bank account to the bank account of Bangkok Subway Contactless Payment System.

In step 86, wallet operator A in Thailand transmits transaction information to central wallet operator. The transaction information which shows that wallet operator B in Hong Kong owes 1,000 THB to wallet operator A in Thailand.

Again based on prearranged rules, the central wallet operator 70 calculates the balance of credit and debit between wallet operator A in Thailand and wallet operator B in Hong Kong. In this case, the amount equals the sum of 1,000 THB (cost of subway ride) and 10 THB (50% of foreign exchange fee for conversion of HK$ to THB). Thus, wallet operator B in Hong Kong owes THB 900 to wallet operator A in Thailand.

In step 88, the central wallet operator 70 informs wallet operator B in Hong Kong that it owes THB 900 to the central wallet operator.

In step 90, wallet operator A in Thailand receives direct bank transfer for THB 900 (minus any transfer fee and exchange rate fee) from wallet operator B in Hong Kong.

FIG. 8 illustrates a process flow of a remote charge and recharge of stored value in the smart mobile device according to the present invention. While a conventional contactless payment system requires a physical and specialized terminal such as an ATM (automatic teller machine) for charging and recharging the stored value of the chip 16, the present invention allows the smart mobile device 10 to be charged and recharged anywhere without requiring a physical terminal.

First as a preliminary step, the user selects a “charge” or “recharge” function displayed by the mobile application 2 running on the mobile device 10. The user can select whether to recharge from his bank account or from his payment card by selecting “Source of Funds” on the menu. In this example, the user's source of funds used for the recharge is a bank account. The user can also modify the recharge amount by selecting “Change amount” on the menu.

In step 120, using an Internet connection enabled with the user's mobile device 10 (e.g., GPRS), the mobile application 2 transmits the recharge instruction to the service operator 48 computer. The service operator 48 identifies the user in its database.

In step 122, the service operator 48 queries the wallet operator 50 to check for service and user status. In step 124, if the user is a valid subscribing member of the wallet operator and is not in a delinquent status, the wallet operator 50 confirms recharge status availability to the service operator 48.

In step 126, the service operator 48 then queries the user's bank 49 to confirm that the user has registered his bank account to be able to use this bank account for recharge of the electronic purse. In step 128, a bank application software running in the bank 49 computer checks the user status and confirms to the service operator 48 the registration of the bank account for recharging.

Step 130 through 136 involve an important authentication procedure to authenticate the user. In step 130, using the internet connection (e.g., GPRS) enabled with the user's mobile device 10, the service operator requests the user to confirm the recharge by asking to enter an authentication information such as the personal identification number (PIN) that the user has selected when he registered with the bank 49 to be able to use his bank account for recharge of the electronic purse.

In step 132, the mobile application 2 running on the mobile device 10 receives the PIN from the user. For security the mobile application 2 encrypts the received PIN using the user bank's encryption key which was loaded into the mobile application 2 in the secure memory area. The exact technology for encryption will be determined by each participating banks policy. The encrypted PIN is transmitted directly to the user's bank via the Internet connection (e.g., GPRS) over a secure communication channel (e.g., SSL). It is important to recognize that the communication channel transmission established for step 132 between the mobile device 10 and the user bank 49 is different from the communication channel between the mobile device 10 and the service operator 48, and between the service operator 48 and the user bank 49 in order to provide secured PIN transmission.

In step 134, the user bank 49 decrypts the received PIN with its own key and validates the PIN based on its customer database. The bank 49 then update the mobile device 10 with a transaction status via the same secured communication channel (e.g., GPRS). In step 136, the user bank 49 updates the service operator 48 with the transaction status and recharge approval code over a different communication channel.

In step 138, the service operator confirms to the wallet operator 50 the approval of the recharge and the recharge approval code issued by the user's bank. In turn, in step 140, the wallet operator 50 confirms receipt of recharge data from the service operator 48.

In step 142, using the Internet connection (e.g., GPRS), the service operator 48 updates over another communication channel the mobile application 2 running in the mobile device 10 with the value of the recharge approved by the user's bank and confirmed by the wallet operator.

In step 144, the user's bank 49 transfers the money corresponding to the recharge instruction given by the user in the above steps from the user's bank account to the wallet operator's bank account in accordance with the settlement process and agreement between the bank 49 and the wallet operator.

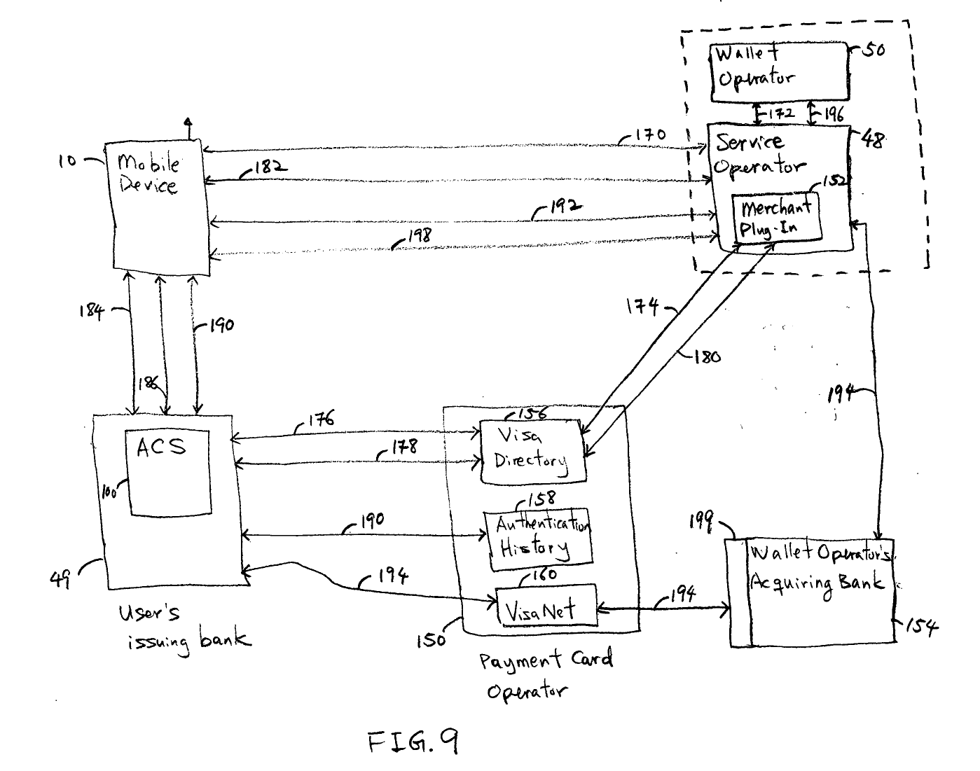

FIG. 9 illustrates an alternative process flow of a remote charge and recharge of stored value in the smart mobile device according to the present invention. Specifically, FIG. 9 illustrates funding of the electronic purse through a payment cards issuing bank using a Visa 3-D Secure standard.

The overall process flow is as follows. The user requests a recharge from the mobile application 2. This connects the mobile device 10 to the MPI 152 at the service operator 48. The MPI 152 is considered to be a part of the service application 35. The MPI then performs an enrollment check with the Visa Directory 156 which uses the user's issuing bank 49 for the check. Once the issuing bank 49 performs the enrollment check, it sends a predetermined URL which is then passed by the Visa Directory 156 to the MPI 152. The MPI 152 passes the same URL to the mobile device 10. The user enters the PIN which is then posted to the ACS at the predetermined URL over an SSL connection. Once the PIN is validated by the issuing bank 49, a confirmation message is sent back to the MPI 152 located at the service operator 48 using the mobile device 10 as a relay. The confirmation message is then used in the traditional authorization process.

In step 170, the user who wants to recharge the stored value in the mobile device 10 using the user's payment card such as Visa, MasterCard, or JCB in accordance with Visa 3-D Secure specifications sends a recharge instruction to the service operator 48. The example discussed herein is based on recharging the stored value using a Visa payment card. The user's recharge instruction is transmitted to the service operator 48 via Internet connection enabled with the user's mobile device (e.g., GPRS) 10. A more detailed recharge operation is described below.

In step 172, the service operator 48 identifies the user in its database and queries the wallet operator 50 to check for service and user status. The wallet operator 48 confirms recharge status availability to the service operator 48.

In step 174, using a Merchant Plug-In (MPI) software 152 (based on Visa 3-D specifications) deployed at the service operator 50, the service operator queries Visa Directory server 156 to locate the user's payment card issuing bank's authentication service based on user's payment card's range.

In step 176, the Visa Directory server 156 queries issuing bank's access control server (ACS) software (based on Visa 3-D specifications) to confirm that the user's card range is within range of cards issued by issuing bank.

In step 178, the ACS at issuing bank confirms that the user's card range is within the range of cards issued by issuing bank and provides to Visa Directory 156 the ACS Uniform Resource Locator (URL) for MPI 152 to post user's authentication request.

In step 180, Visa Directory 156 confirms to MPI 152 at the service operator 48 that the user can be authenticated and provides the ACS's URL. In step 182, using the Internet connection (e.g., GPRS) enabled with the user's mobile device 10, the MPI 152 deployed at the service operator 48 forwards a URL of the ACS to the mobile device (issuing bank ACS). The mobile device redirects the user to this URL Where the user enters their PIN. On the HTTP form POST the PIN is sent to the ACS over a secure SSL connection. The ACS validates the PIN, creates an encrypted response which is returned to the mobile device. The mobile device then relates this encrypted information back to the MPI.

In step 184, the user's authentication request is transmitted to the issuing bank's ACS via the Internet connection (e.g., GPRS) enabled with the user's mobile device 10.

In step 186, via the Internet connection, the issuing bank's ACS directly requests on the user's mobile device to provide his VBV (Verified By VISA) PIN. The user enters the VBV PIN on the mobile device 10, which is directly transmitted to the issuing bank's ACS computer 100 using SSL. The ACS authenticates the VBV PIN.

In step 190, the issuing bank's ACS forwards the user authentication result (status) directly to Visa History Server 158 for reference purposes and to the mobile application 2. In step 192, the authentication result (status) received by the mobile application 2 is then transmitted to the MPI 152 at the Mobile Smart Service Operator with the user's mobile device 10 acting as a relay (in accordance with Visa 3-D Secure specifications) via the Internet connection enabled with the user's mobile device.

In step 194, upon receipt of the authentication result from the mobile device 10, the service operator 48 submits the recharge transaction for approval to the payment gateway 199 of the wallet operator's acquiring bank 154 which is transmitted to the VisaNet 160. Using Visa's process for conventional transaction authorization, the acquiring bank's payment gateway 199 confirms transaction authorization (or denial) to the service operator 48.

In step 196, the service operator 48 confirms to the wallet operator 50 the approval of the recharge and the wallet operator confirms receipt of recharge data from the service operator.

In step 198, using the Internet connection, the service operator 48 updates the mobile application 2 with the value of the recharge approved using the Visa system and confirmed by the wallet operator 50.

Finally, the wallet operator's acquiring bank 154 transfers the money corresponding to the recharge instruction given by the user as described in the above steps to the wallet operator's bank account in accordance with the settlement process and agreement between the acquiring bank and the wallet operator 50. The user's issuing bank will charge the user and will transfer funds to the acquiring bank based on Visa's standard settlement process.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

1. A system for facilitating contactless payment transactions across a plurality of different contactless payment systems using a user's mobile device that acts as a stored value device, comprising:
a communication module coupled to the mobile device and operable to emulate different transmission standards used by the plurality of different contactless payment systems;
a mobile application executable in the mobile device acting as the stored value device and being associated with a second contactless payment system, the mobile application together with the communication module operable to emulate the transmission standard and data exchange format used by a first contactless payment system unassociated with the mobile device to perform a first contactless payment transaction with a first merchant associated with the first payment system; and
a service application executable in a service operator computer and operable to communicate with the first and second payment systems to settle the amount owed to the first payment system by the second payment system according to the performed first contactless payment transaction.

2. The system according to claim 1, wherein the service operator computer is a central service computer and the service application is a central service application running on the central service computer, further comprising:
a first service application running on a first service computer of the first payment system and operable to transmit a payment request to the central service application according to the performed first payment transaction; and
a second service application running on a second service computer of the second payment system and operable to receive a payment request from the central service application according to the performed first payment transaction.

3. The system according to claim 1, further comprising an account application executable in a computer of a financial institution that holds an account of the user, wherein in response to a recharge request from the user, the mobile application sends user authentication information directly to the account application over a secure communication channel without involving the service application to perform direct authentication between the user and the financial institution.

4. The system according to claim 3, wherein:
the account application authenticates the user based on the received authentication information and sends a recharge request status to the mobile application over the secure communication channel; and
the account application sends a recharge approval to the service application over a first communication channel that is different from the secure communication channel.

5. The system according to claim 3, wherein the service application sends to the mobile device an approval of the recharge request upon receipt of the recharge approval from the account application.

6. The system according to claim 5, wherein the service application sends a request to store a new stored value to the mobile device reflecting the amount of the recharge.

7. The system according to claim 1, further comprising:
an account application executable in a computer of a financial institution that holds a credit card account of the user, wherein in response to a recharge request from the user, the mobile application sends user authentication information directly to the account application over a secure communication channel, wherein:
the recharge request is a request to recharge from the credit card account of the user and the financial institution is an issuing bank for the user's credit card;
the account application transmits a user authentication status to the service application using the mobile device as a relay; and
upon receiving the user authentication status from the mobile device, the service application transmits a recharge approval request to a computer of a wallet operator's acquiring bank, the wallet operator being associated with the service operator of the second contactless payment system.

8. The system according to claim 1, wherein:
upon performing the first contactless payment transaction, the mobile application generates a payment message containing an encrypted clearing message for transmission to a merchant application running on a computer of the first merchant; and
the encrypted clearing message is decryptable by the service application, but is undecryptable by the merchant application.

9. The system according to claim 8, wherein the payment message contains an encrypted merchant confirmation message decryptable by the merchant application.

10. The system according to claim 1, wherein the mobile device includes a wireless telephone and the communication module coupled to the mobile device includes an NFC (near-field communications) chip.

11. The system according to claim 1, further comprising a cross border application running on the mobile device and operable to convert the currency of the stored value contained in the mobile device to a selected foreign currency.

12. A system for facilitating contactless payment transactions across a plurality of different contactless payment systems using a user's mobile device that acts as a stored value device, comprising:
a mobile application executable in the mobile device acting as a stored value device and being associated with one of the plurality of contactless payment systems and unassociated with other ones of the plurality of contactless payment systems, the mobile application operable to perform contactless payment transactions with merchants associated with any one of the plurality of contactless payment systems by emulating the transmission standards and data exchange formats used by the plurality of contactless payment systems;
a service application executable in a service operator computer operable to communicate with the plurality of contactless payment systems to settle the amounts owed to the other contactless payment systems by the one contactless payment system associated with the mobile device according to the contactless payment transactions performed by the mobile device with the other contactless payment systems.

13. The system according to claim 12, wherein the service computer is a central service computer and the service application is a central service application running on the central service computer, further comprising:
a service application running on and associated with a computer of each of the plurality of contactless payment systems, each service application operable to transmit a payment request to the central service application according to the payment transactions performed by the mobile device in the associated payment system, and further operable to receive payment requests from the central service application according to the payment transactions performed by the mobile device in the other payment systems.

14. The system according to claim 12, further comprising an account application executable in a computer of a financial institution that holds an account of the user, wherein in response to a recharge request from the user, the mobile application sends user authentication information directly to the account application over a secure communication channel without involving the service application to perform direct authentication between the user and the financial institution.

15. The system according to claim 12, further comprising:
an account application executable in a computer of a financial institution that holds a credit card account of the user, wherein in response to a recharge request from the user,
the mobile application sends user authentication information directly to the account application over a secure communication channel, wherein:
the recharge request is a request to recharge from the credit card account of the user and the financial institution is an issuing bank for the user's credit card;
the account application transmits a user authentication status to the service application using the mobile device as a relay; and
upon receiving the user authentication status from the mobile device, the service application transmits a recharge approval request to a computer of a wallet operator's acquiring bank, the wallet operator being associated with the one contactless contactless payment system.

16. The system according to claim 12, wherein:
upon performing a first contactless payment transaction with a first merchant associated with one contactless payment system, the mobile application generates a payment message containing an encrypted clearing message for transmission to a merchant application running on a computer of the first merchant; and
the encrypted clearing message is decryptable by the service application, but is undecryptable by the merchant application.

17. The system according to claim 12, wherein the mobile device includes a wireless telephone and an NFC (near-field communications) chip coupled to the mobile device.

18. The system according to claim 12, further comprising a cross border application running on the mobile device and operable to convert the currency of the stored value contained in the mobile device to a selected foreign currency.

19. A method of facilitating contactless payment transactions across a plurality of different contactless payment systems using a user's mobile device that acts as a stored value device, comprising the steps of:
performing by a mobile device a first contactless payment transaction with a first merchant associated with a first contactless payment system, wherein a mobile application is executed in the mobile device acting as the stored value device and the mobile device is associated with a second contactless payment system, the step of performing a first contactless payment transaction including the step of emulating by the mobile application and the mobile device the transmission standard and data exchange format used by the first contactless payment system unassociated with the mobile device;
communicating with the first and second payment systems by a service application executable in a service operator computer in order to settle the amount owed to the first payment system by the second payment system.

20. The method according to claim 19, wherein the service computer is a central service computer and the service application is a central service application running on the central service computer, and wherein the step of communicating includes:
transmitting a payment request to the central service application from a first service application running on a first service computer of the first payment system according to the performed first payment transaction;
receiving from the central service application a payment request by a second service application running on a second service computer of the second payment system according to the performed first payment transaction.

21. The method according to claim 19, wherein an account application is executed in a computer of a financial institution that holds an account of the user, further comprising the step of:
in response to a recharge request from the user, transmitting from the mobile application user authentication information directly to the account application over a secure communication channel without involving the service application to perform direct authentication between the user and the financial institution.

22. The method according to claim 21, wherein the step of transmitting from the mobile application user authentication information includes:
authenticating by the account application the user based on the received authentication information;
upon authentication,
transmitting a recharge request status to the mobile application over the secure communication channel; and
transmitting a recharge approval to the service application over a first communication channel that is different from the secure communication channel.

23. The method according to claim 22, further comprising the step of:
transmitting by the service application to the mobile device an approval of the recharge request upon receipt of the recharge approval from the account application.

24. The method according to claim 21, wherein the recharge request is a request to recharge from a credit card account of the user and the financial institution is an issuing bank for the user's credit card, further comprising:
transmitting by the account application a recharge request status to the service application using the mobile device as a relay; and
transmitting by the account application a recharge approval status to a computer of a credit card operator associated with the credit card of the user.

25. The method according to claim 19, wherein:
upon performing the first contactless payment transaction, generating by the mobile application a payment message containing an encrypted clearing message for transmission to a merchant application running on a computer of the first merchant, the encrypted clearing message being decryptable by the service application, but undecryptable by the merchant application.

26. The method according to claim 19, wherein the step of emulating by the mobile application and the mobile device the transmission standard and data exchange format includes using the mobile application and an NFC (near-field communications) chip coupled to the mobile device to emulate the transmission standard and data exchange format.

27. The method according to claim 19, prior to performing the first contactless payment transaction, further comprising converting the currency of the stored value contained in the mobile device to a selected foreign currency.

28. The method according to claim 19, prior to performing a first contactless payment transaction, further comprising determining the payment system in use among the plurality of different contactless payment systems.

29. The method according to claim 28, wherein the step of determining the payment system in use includes automatically determining the payment system in use according to an identifier transmitted by the first merchant.
